(19) United States
(12) Patent Application Publication
(10) Pub. No.: US 2002/0042981 A1
(43) Pub. Date: Apr. 18, 2002

(54) System for lifting and assembling re-bar cages

(76) Inventors: Bryon D. Barnum, Hopkins, SC (US); Otis Norris, Bethane, SC (US)

Correspondence Address: Douglas A. Collier, Woodard, Emhardt, Naughton, Moriarty and McNett, Bank One Center/Tower, 111 Monument Circle, Suite 3700, Indianapolis, IN, 46204-5137, US

(21) Appl. No.: 09/975,237

(22) Filed: Oct. 11, 2001

Related U.S. Application Data
(60) Provisional application No. 60/239,989, filed on Oct. 13, 2000.

(51) Int. Cl. B23P 11/00

(52) U.S. Cl. 29/464; 29/281.5

(57) ABSTRACT

Systems and methods for assembling re-bar cages are provided that minimize or eliminate manual lifting of re-bar. The system is adjustable to accommodate the size of the re-bar cage and the field conditions in which the system is to be employed. Various methods for assembling re-bar cages with the system are also provided.

### CROSS-REFERENCE TO RELATED APPLICATION

The present application claims the benefit of the filing date of Provisional Application No. 60/239,989 filed Oct. 13, 2000.

### BACKGROUND OF THE INVENTION

The present invention relates generally to construction equipment, and more particularly to a device for lifting and assembling re-bar cages.

Concrete structures use reinforcing steel or re-bar in the interior of the concrete to provide bending and tensile strength to the structure. Typical structural components that are included in concrete structures include, for example, beams, columns, piers, and footings. During construction, forms for the structural components are built at the desired location in the concrete structure, and the reinforcing steel is positioned in the forms before the concrete is placed. Oftentimes, the reinforcing steel used in the structural components is in the form of a re-bar cage that is sized and configured to position the reinforcing steel adjacent the perimeter of the structural component while providing a sufficient depth of concrete cover over the re-bars. Placement of the reinforcing steel adjacent the perimeter of the structural component positions the re-bar where it is most effective at resisting the bending and tensile loading to which the structural component is subjected.

One problem with re-bar cages is that the cages are difficult to assemble. The re-bar cage is typically assembled at the construction site before the cage is positioned in the concrete forms. The re-bar cage includes a number of main re-bars that extend along the length of the cage, and a number of transverse re-bars are spaced along the length of the main re-bars and tied to the main re-bars. Typically, the transverse re-bars have a shape that corresponds to the desired perimeter shape of the cage, such as a circular, square or rectangular shape. In order to assemble these cages, the main re-bars are laid on or parallel to the ground next to the transverse re-bars. Workers must then lift one of the main re-bars manually and feed it through the transverse bars to position it adjacent the desired location on the inner perimeter of the transverse re-bars, and then tie the lifted main re-bar to each of the transverse re-bars. This lifting and tying procedure is repeated for each of the main re-bars.

Since the main re-bars can be quite heavy and long, and the transverse re-bars can be sized to form a cage that can be several feet in height when laid on the ground, the required lifting of the main re-bars can be difficult, time consuming, and can also cause worker injury. In addition, site conditions such as changing grade, mud, snow and other environmental factors can increase the difficulty in handling the re-bars. Forklifts and cranes can be employed for such lifting; however, such equipment is expensive to operate and can often be better utilized for other tasks on the job site.

What are needed therefore are systems and devices for lifting and assembling re-bar cages which address these problems. The systems and devices should be able to accommodate the lifting and assembly of re-bar cages of various lengths and cross-sectional configurations and sizes, and should be readily adaptable to field conditions encountered at the construction site.

### SUMMARY OF THE INVENTION

The present invention provides systems and methods for assembling re-bar cages that minimizes or eliminates manual lifting of re-bar. The system is adjustable to accommodate the size of the re-bar cage and the field conditions in which the system is to be employed. Various methods for assembling re-bar cages with the system of the present invention are also provided.

Further aspects, forms, features, embodiments, applications and advantages of the present invention will be apparent from the following description of the illustrated embodiments.

### BRIEF DESCRIPTION OF THE DRAWINGS

FIG. 1 is a perspective view of the re-bar lifting and assembling system according to the present invention showing a staging re-bar and a plurality of main re-bars lifted into an initial position by a hoist assembly.

FIG. 2 is an exploded view of a frame forming a portion of the re-bar lifting and assembly system of FIG. 1.

FIG. 3 is a perspective view of the system of FIG. 1 with a support member secured to the forward and rearward frames of the system.

FIG. 4 is a perspective view of the system of FIG. 1 showing transverse re-bars spaced along the staging re-bar.

FIG. 5 is a perspective view of the system of FIG. 1 with the main re-bars positioned on the support member and the partially assembled cage supported by the hoist assembly.

FIG. 6 is a perspective view of the system of FIG. 1 with the main re-bars positioned on the support members and the partially assembled cage lowered with respect to the support members.

FIG. 7 is an elevational view of another embodiment frame according to the present invention.

FIG. 8 is an elevational view of a stanchion comprising a portion of the frame of FIG. 7.

FIG. 9 is an elevational view of an upper arm comprising a portion of the frame of FIG. 7.

FIG. 10 is an elevational view of a connecting member comprising a portion of the frame of FIG. 7.

FIG. 11 is an exploded elevational view of a temporary frame according to another aspect of the present invention.

FIG. 12 is a diagrammatic perspective view of the re-bar lifting and assembling system according to the present invention showing a temporary frame between a forward frame and a rearward frame.

FIG. 13 is an enlarged detailed view of the connection of the temporary frame to the forward frame of FIG. 12.

FIGS. 14a-14c illustrate various steps of assembling a re-bar cage according to another aspect of the present invention.

### DESCRIPTION OF THE ILLUSTRATED EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any such alterations and further modifications in the illustrated embodiments, and any such further applications of the principles of the invention as illustrated therein are contemplated as would normally occur to one skilled in the art to which the invention relates.

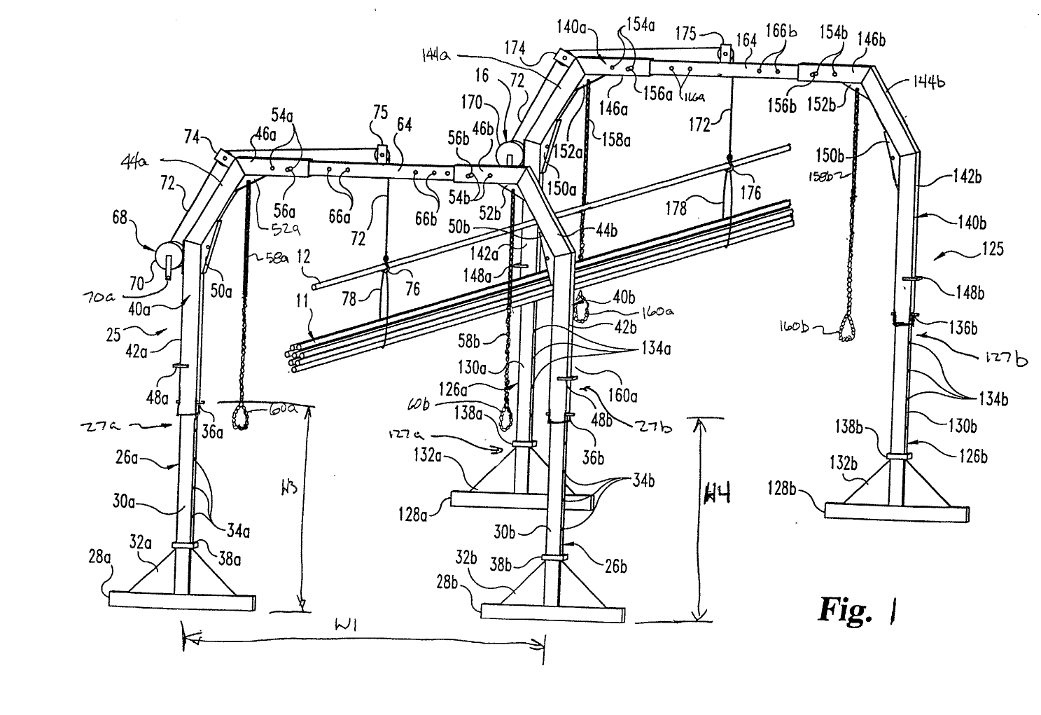

Referring now to FIG. 1, there is illustrated a perspective view of a re-bar lifting and assembly system 20 according to the present invention. System 20 includes a first forward frame 25 and a second rearward frame 125 that is spaced a distance from forward frame 25 during use. Forward frame 25 includes a hoist assembly 68 extending into a working space defined by forward frame 25, and rearward frame 125 includes a hoist assembly 168 extending into a working space defined by rearward frame 125. Hoist assemblies 68, 168 of frames 25, 125 support a respective one of the opposite ends of a plurality of main re-bars 11. Main re-bars 11 comprise the longitudinally extending re-bars of a cage that is positioned in formwork for a structural component of a reinforced concrete structure. Such structural components include, for example, columns, beams, caissons, footings, piers and caps. The structural components and/or re-bar cage placed into the formwork can have circular, non-circular, square, rectangular, L-shaped, or other cross-sectional shape as would occur to those of ordinary skill in the art. Each main re-bar 11 can also have a circular, square, or other cross-sectional shape.

In the discussion that follows, it will be understood that rearward frame 125 is substantially identical to forward frame 25. Thus, it will be understood that the elements of frame 125 are designated with a “100” series reference numeral, and that the last two numbers in the reference numeral for the elements of frame 125 correspond to the reference numeral used for the corresponding element of frame 25. Additionally, while two frames have been illustrated, it should be understood that three or more frames could be used with system 20 if necessary due to the length and weight of the re-bars being supported thereby.

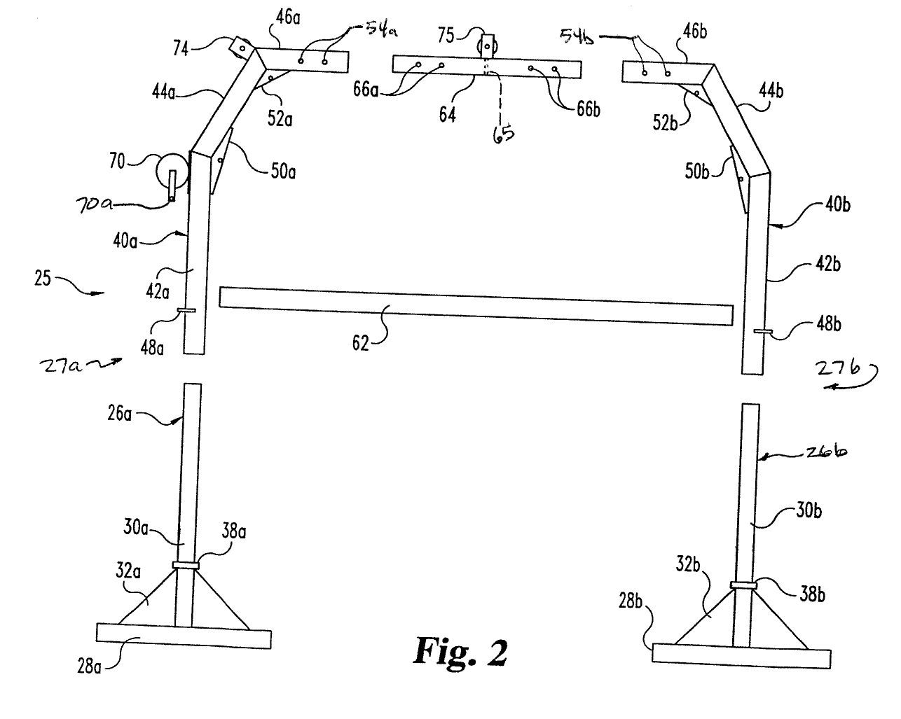

Referring now additionally to FIG. 2, forward frame 25 includes a first column 27a having a first stanchion 26a and a second column 27b having a second stanchion 26b. First and second stanchions 26a, 26b support frame 25 on the ground surface. Stanchion 26a includes a base 28a resting on the ground surface and a lower vertical member 30a extending upwardly from base 28a. A base stiffener 32a, which is in the form of a gusset plate in the illustrated embodiment, extends between base 28a and lower vertical member 30a to provide stability to stanchion 26a. Other types of base stiffeners are also contemplated, such as a knee-brace or other moment-resistant connection. Lower vertical member 30a includes a number of vertical adjustment holes 34a and a vertical adjustment pin 36a. A stop member 38a is provided around lower vertical member 30a above stiffener 32a. Stanchion 26b is similarly arranged and includes a base 28b, a lower vertical member 30b, and a base stiffener 32b extending between base 28b and lower vertical member 30b. Lower vertical member 30b includes a number of vertical adjustment holes 34b and a vertical adjustment pin 36b. A stop member 38b is provided around lower vertical member 30b above stiffener 32b.

First column 27a of frame 25 further includes a first upper arm 40a, and second column 27b of frame 25 includes a second upper arm 40b. First upper arm 40a is telescopingly positioned over and adjustably connected to lower vertical member 30a of first stanchion 26a, and second upper arm 40b is telescopingly positioned over and adjustably connected to lower vertical member 30b of second stanchion 26b. Stop members 38a and 38b establish a minimum height for the frame 25 by limiting the downward movement of the upper arms 40a and 40b over the lower vertical members 30a and 30b, respectively.

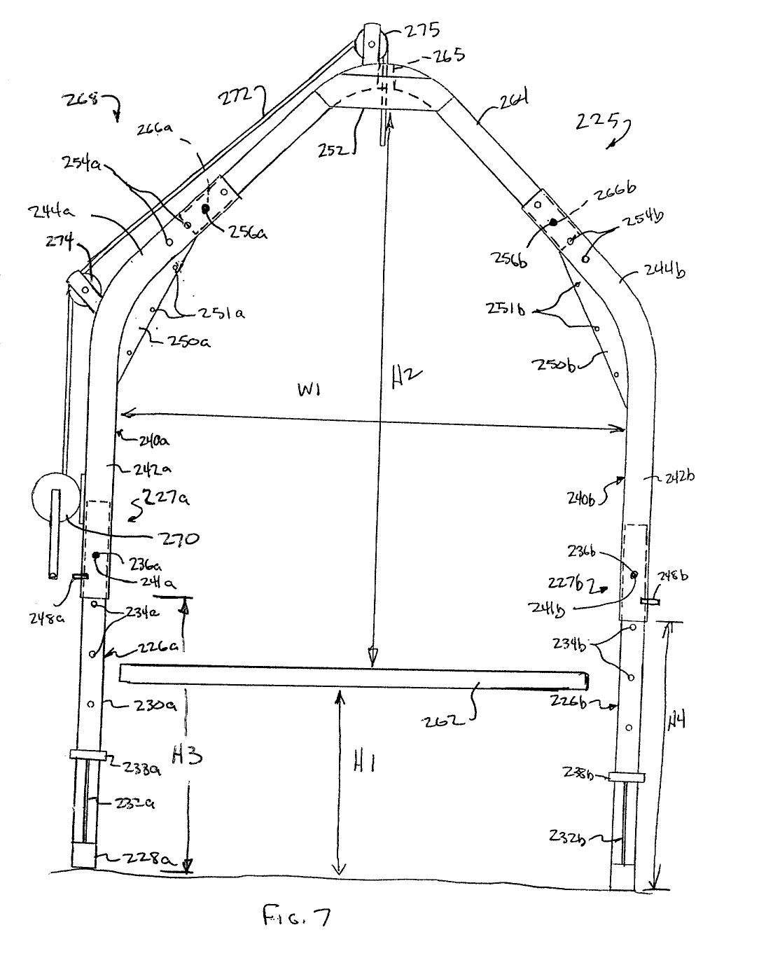

First upper arm 40a includes an upper vertical member 42a adjacent lower vertical member 30a and a first transverse member 44a extending at an angle from upper vertical member 42a toward second upper arm 40b and to a second transverse member 46a extending generally in a horizontal direction toward second upper arm 40b. A lower stiffener 50a stiffens the connection between first transverse member 44a and upper vertical member 42a, and an upper stiffener 52a extends between first transverse member 44a and second transverse member 46a to stiffen the connection therebetween. In the illustrated embodiment, stiffeners 50a and 52a are in the form of a gusset plate; however, other types of stiffeners are also contemplated, such as a knee-brace or a moment-resistant connection. A handle 48a is provided on upper vertical member 42a in order to facilitate lifting of first upper arm 40a to reposition upper arm 40a along lower vertical member 30a of first stanchion 26a. It is also contemplated that plates 32a, 32b could be replaced with pipe or tubular members, such as discussed below with respect to FIG. 8 and stiffeners 232a, 232b. Such tubular members could serve as a handle to facilitate lifting and handling of the stanchions.

Second upper arm 40b includes an upper vertical member 42b adjacent lower vertical member 30b and a first transverse member 44b extending from upper vertical member 42b toward first upper arm 40a to a second transverse member 46b extending in a generally horizontal direction toward first upper arm 40a. A lower stiffener 50b stiffens the connection between first transverse member 44b and upper vertical member 42b, and an upper stiffener 52b extends between first transverse member 44b and second transverse member 46b to stiffen the connection therebetween. A handle 48b is provided on upper vertical member 42b in order to facilitate lifting of upper arm 40b to reposition upper arm 40b along lower vertical member 30b of second stanchion 26b.

The heights H3, H4 of each of the upper arms 40a, 40b above the base 28a, 28b can be individually adjusted by repositioning vertical adjustment pins 36a, 36b in any one of the vertical adjustment holes 34a, 34b formed in lower vertical members 30a, 30b respectively. In one specific embodiment, it is contemplated that holes 34a, 34b provide a working space height adjustment in six inch increments, although other increments are also contemplated. It will be understood that height H3 between first base 28a and first upper arm 40a can be different than the height H4 between second base 28b and second upper arm 40b to provide a level frame 25 to accommodate an uneven ground or floor surface. Furthermore, adjustment holes 34a, 34b allow the working space height of frame 25 to be adjusted to accommodate re-bar cages of various heights. Other means for adjustably securing upper arms 40a, 40b to lower vertical members 30a, 30b are also contemplated, such as, for example, collars that are adjustably secured to the columns. In another alternative, upper arms 40a, 40b could be telescopingly received in lower vertical members 30a, 30b.

Second transverse member 46a of upper arm 40a includes a number of horizontal adjustment holes 54a, and second transverse member 46b of upper arm 40b includes a number of horizontal adjustment holes 54b. A connecting member 64 extends between and is telescopingly received in or over second transverse members 46a and 46b. Connecting member 64 includes a number of first bores 66a proximate second transverse member 46a that are alignable with horizontal adjustment holes 54a. Connecting member 64 further includes a number of second bores 66b proximate second transverse member 46b that are alignable with horizontal adjustment holes 54b. Horizontal adjustment pins 56a and 56b secure upper arms 40a and 40b, respectively, to connecting member 64. The working spacing width W1 between first stanchion 26a and second stanchion 26b can thus be adjusted to accommodate re-bar cages of various widths. In one specific embodiment, it is contemplated that bores 66a, 66b provide working space width adjustment in four inch increments, although other increments are also contemplated.

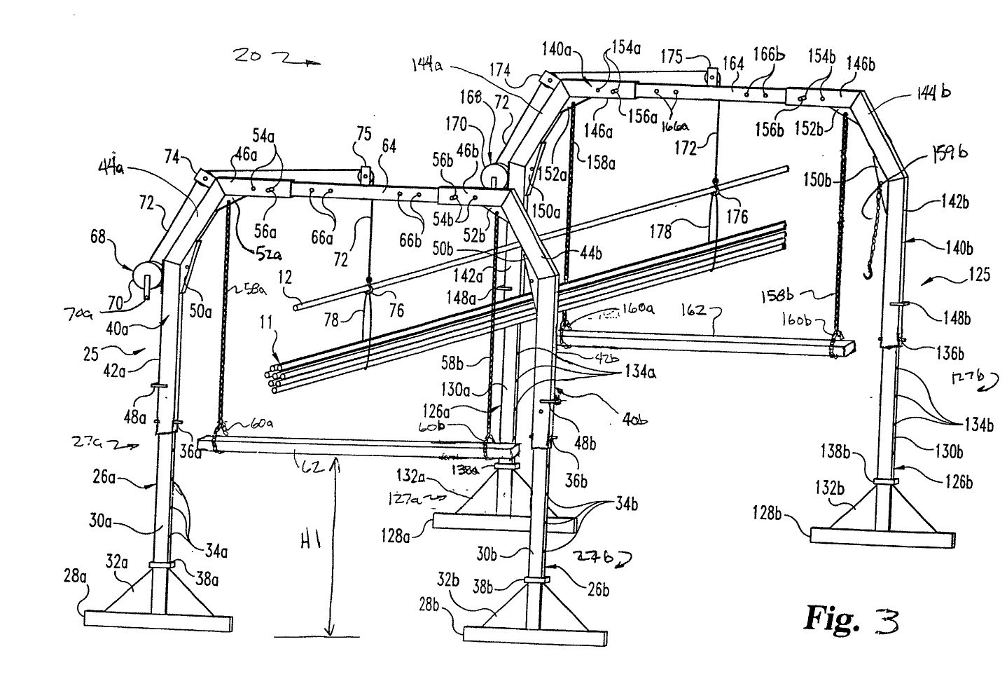

Frame 25 further includes a first support member holder 58a coupled to upper stiffener 52a and a second support member holder 58b coupled to upper stiffener 52b. Support member holders 58a, 58b include receiving portions 60a, 60b, respectively. A support member 62 (FIG. 3) extends at least partially between first column 27a and second column 27b and is removably positioned in receiving portions 60a, 60b. Support member 62 can be positioned at a height H1 that is about waist level above the ground. Height H1 can be adjusted by repositioning vertical adjustment pins 36a, 36b as discussed above, or by extending or reducing the lengths of support member holders 58a, 58b. In the illustrated embodiment, support member holders 58a, 58b are in the form of chains and receiving portions 60a, 60b are loops formed by looping the chain and hooking it back onto itself. The length of support member holders 58a, 58b can thus be easily adjusted by changing the size of the loop. However, other forms for the holders and receiving portions are also contemplated, such as a cable or other flexible member, a relatively stiff holder that has a receiving portion adapted for attachment and removal of support member 62 as needed, or saddles attached to the inner sides of columns 27a, 27b.

In the illustrated embodiment, support member holders 58a, 58b are coupled to upper stiffeners 52a, 52b. However, it should be understood that support member holders 58a, 58b can be coupled to lower stiffeners 50a, 50b, or otherwise directly attached to a component of frame 25. Furthermore, supplemental support members can be coupled to frames 25, 125, such as supplemental support member 159b of FIG. 3 coupled to upper stiffener 152b. Supplemental support members can also be provided on upper stiffeners 52a, 52b, 152a. In one embodiment, four supplemental support members each in the form of a chain are coupled to each of the upper stiffeners 52a, 52b, 152a, 152b, while support member holders 58a, 58b, 158a, 158b are coupled to lower stiffeners 50a, 50b, 150a, and 150b. These supplemental support members can be engaged to the re-bar cage assembly to help cable 72 support its load and also to help prevent lateral movement of the re-bar cage as it is assembled.

Also provided on frame 25 is a hoist assembly 68. In the illustrated embodiment, hoist assembly 68 is engaged to first upper arm 40a, although hoist assembly 68 could alternatively be positioned on second upper arm 40b. Hoist assembly 68 includes a winch 70, a first pulley 74 secured on upper arm 40a, and a second pulley 75 secured to connecting member 64. A main cable 72 extends from winch 70 through pulleys 74, 75 and downwardly through an opening 65 provided through connecting member 64 between first upper arm 40a and second upper arm 40b. A hook 76 is coupled at the end of main cable 72. Cable 72 can be swaged at its connection with hook 76, and the swaged connection can be received into opening 65 to maximize the lifting height of hoist assembly 68.

A lower lifting assembly 78, which can be a chain, cable or the like, is looped around a staging re-bar 12. Staging re-bar 12 is positioned in hook 76, and a plurality of main re-bars 11 are positioned in lower lifting assembly 78. Hook 76 can be provided with a pivoting safety latch to securely hold staging re-bar 12 therein. It is also contemplated that lower lifting assembly 78 can be coupled to hook 76 and staging re-bar 12 can be initially lifted off the ground into the working space along with main re-bars 11 by lower lifting assembly 78. Once the re-bars are lifted, support members 62, 162 are coupled to frames 25, 125 and the re-bars are lowered onto and supported by support members 62, 162. Staging re-bar 12 can then be placed into hook 76 and lifted above the main re-bars 11 on support members 62, 162.

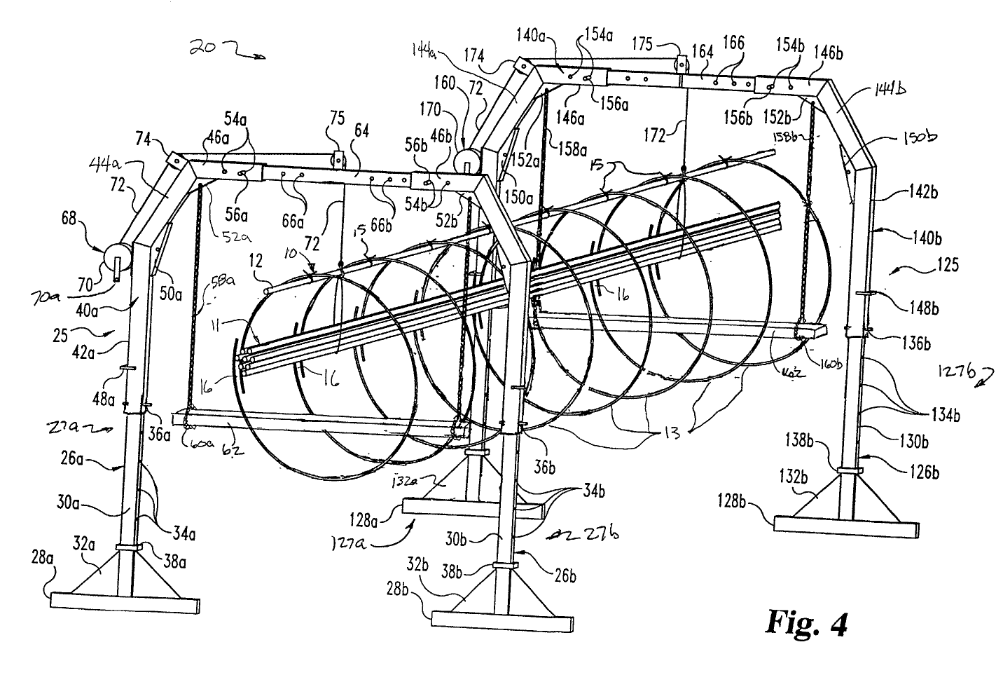

As described in further detail below, winch 70 facilitates the raising and lowering of main re-bars 11 and staging re-bar 12 along with the transverse bars 13 (FIG. 4) with respect to the ground surface and support members 62, 162. Winch 70 is preferably a hand-cranked ratcheting-type lifting mechanism that allows a worker to easily accomplish the desired lifting and lowering of the re-bars. Winch 70 is lockable to maintain the desired elevated position of the re-bars. Winch 70 can be provided with a friction brake that automatically prevents re-bars from lowering unless the brake is released. It is further contemplated that winch 70 can include crank handle 70a, which can be removable and keyed to winch 70 to prevent unauthorized operation of winch 70. To secure system 20 when not in use, a plurality of re-bars or a re-bar cage assembly can be lifted by hoist assemblies 68, 168 and coupled to the frame with the supplemental support members. Crank handle 70a can then be removed and system 20 left on the job site. The weight of the hoisted re-bars and inability to operate winch 70 without the proper handle will deter theft. A removable crank handle 70a also allows the use of a ratcheting type crank handle if the size of the re-bar cage assembly interferes with crank handle operation. Winch 70 can also be bolted to the frame for easy removal and replacement should it become damaged or otherwise inoperable.

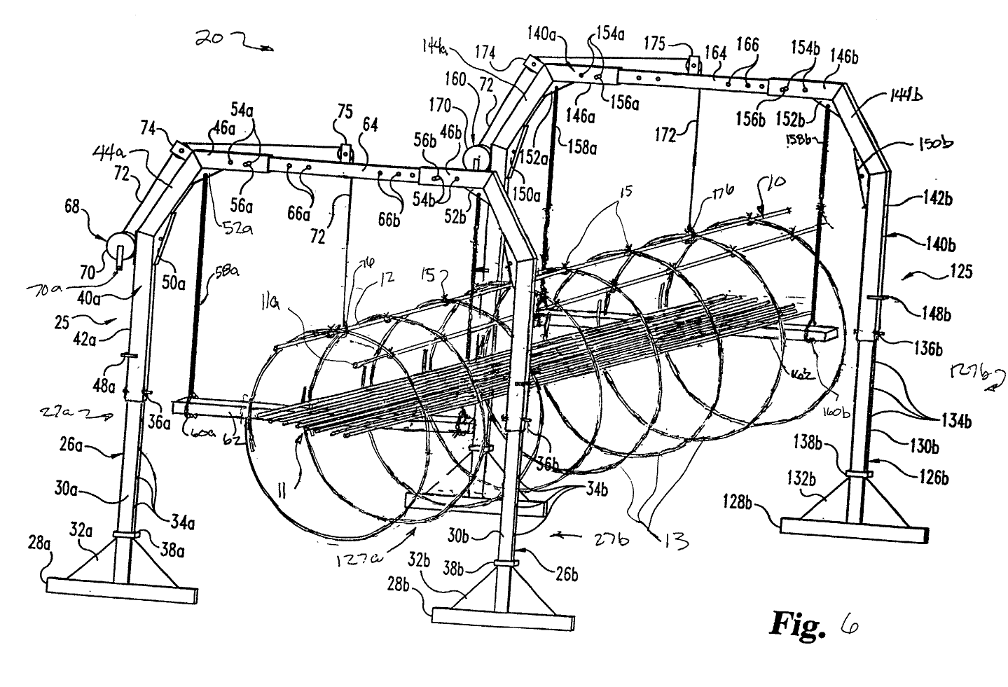

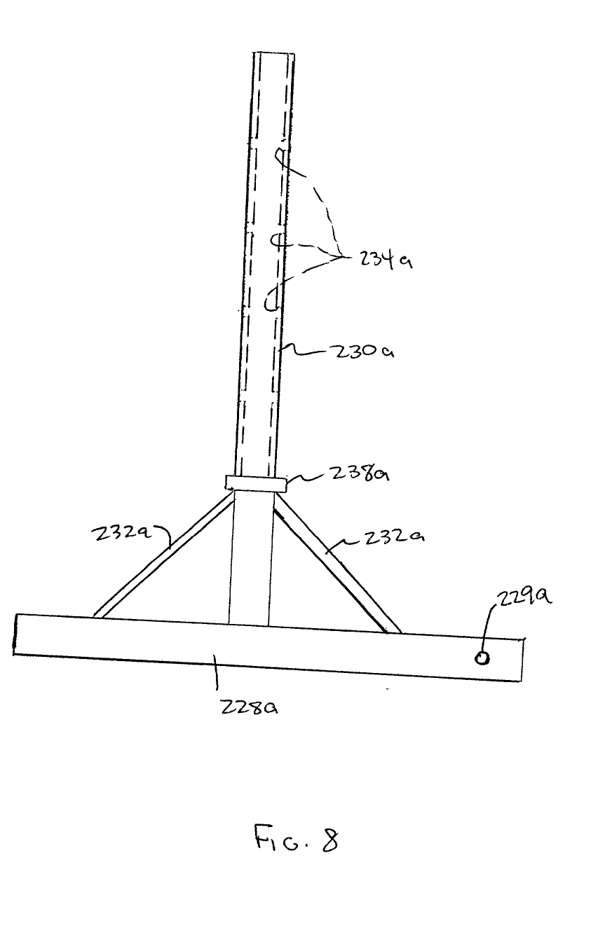

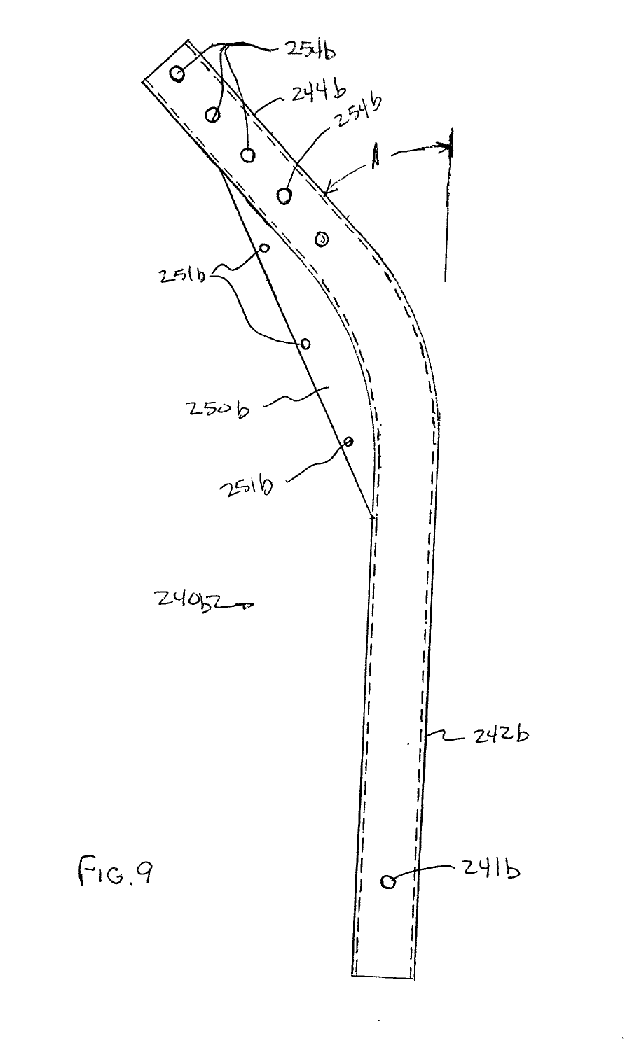

Referring now to FIGS. 7-10, another embodiment frame 225 according to the present invention is shown. It should be understood that two or more frames 225 can be provided and used in the manner discussed above with respect to forward frame 25 and rearward frame 125.

Frame 225 includes a first column 227a having a first stanchion 226a and a first upper arm 240a, and a second column 227b having a second stanchion 226b and a second upper arm 240b. First and second stanchions 226a, 226b support frame 225 on the ground surface. First stanchion 226a includes a base 228a resting on the ground surface and a lower vertical member 230a extending upwardly from base 228a.

A first base stiffener 232a, which is in the form of steel pipe in the illustrated embodiment, extends between base 228a and lower vertical member 230a on each side of lower vertical member 230a to provide stability to first stanchion 226a. A second base stiffener 232b similarly extends between second base 228ba and lower vertical member 230b on each side of lower vertical member 230b to provide stability to second stanchion 226b. In one specific embodiment, base stiffeners 232a, 232b are one inch diameter schedule 40 steel pipe. Other types of base stiffeners are also contemplated, such as gusset plates or moment-resistant connections.

Lower vertical member 230a includes a number of vertical adjustment holes 234a and a vertical adjustment pin 236a. A stop member 238a is provided around lower vertical member 230a above stiffener 232a. Lower vertical member 230b is similarly arranged and includes a number of vertical adjustment holes 234b and a vertical adjustment pin 236b. A stop member 238b is provided around lower vertical member 230b above stiffener 232b. First upper arm 240a is telescopingly positioned over and adjustably connected to lower vertical member 230a of first stanchion 226a, and second upper arm 240b is telescopingly positioned over and adjustably connected to lower vertical member 230b of second stanchion 226b. Stop members 238a and 238b establish a minimum height for frame 225 by limiting the downward movement of upper arms 240a and 240b over lower vertical members 230a and 230b, respectively.

First upper arm 240a includes an upper vertical member 242a and a transverse member 244a extending at an angle A with respect to upper vertical member 242a. A first handle 248a is provided on upper vertical member 242a in order to facilitate lifting of first upper arm 240a to reposition first upper arm 240a along lower vertical member 230a of first stanchion 226a. Second upper arm 240b includes an upper vertical member 242b and a transverse member 244b extending at an angle A with respect to upper vertical member 242b. A second handle 248b is provided on upper vertical member 242b in order to facilitate lifting of second upper arm 240b to reposition second upper arm 240b along lower vertical member 230b of second stanchion 226b.

A first stiffener 250a stiffens the connection between transverse member 244a and upper vertical member 242a of first upper arm 240a. A second stiffener 250b stiffens the connection between transverse member 244b and upper vertical member 242b. In the illustrated embodiment, stiffeners 250a and 250b are in the form of a gusset plate; however, other types of stiffeners are also contemplated, such as a knee-brace or a moment-resistant connection. It is contemplated that transverse members 244a, 244b can be welded, bolted, or otherwise fastened to upper vertical members 242a, 242b, respectively, or can be formed by bending a unitary piece of material to form the desired angle A. Stiffeners 250a , 250b, are provided with a number of holes 251a, 251b to which support member holders or supplemental support members can be attached.

Transverse member 244a of first upper arm 240a includes a number of adjustment holes 254a, and transverse member 244b of second upper arm 240b includes a number of adjustment holes 254b. A connecting member 264 extends between transverse members 244a and 244b. Connecting member 264 has an arch shape with opening 265 centered in the apex of the arch. An arch stiffener 252 extends between lower transverse legs 264a, 264b of connecting member 264. Arch stiffener 252 reduces or eliminates bending deformation of connecting member 264 while lifting the re-bar cage. Connecting member 264 includes first bores 266a proximate transverse member 244a alignable with adjustment holes 254a. Connecting member 264 further includes a second bores 266b alignable with horizontal adjustment holes 254b. Adjustment pins 256a and 256b secure upper arms 240a and 240b, respectively, to connecting member 264.

Re-bar cage designs can often employ circular or square cross-sections, and as such could require a similar adjustment in both height H2 and width W1 of the working space below frame 225 to accommodate the cage. Width W1 between first column 227a and second column 227b and the height H2 of connecting member 264 above support member 262 can be adjusted simultaneously to accommodate re-bar cages of various sizes. In one specific embodiment, it is contemplated that adjustment holes 254a, 254b are spaced 3 inches apart along transverse members 244a, 244b, and transverse members 244a, 244b form an angle A of about 45 degrees with upper vertical members 242a, 242b. In this specific embodiment, adjustment holes 254a, 254b provide a simultaneous adjustment in height H2 and width W1 in about 2.1 inch increments in each dimension. However, it should be understood that other angles A and simultaneous height and width adjustment increments are contemplated. This ability to simultaneously adjust H2 and W1 of the working space reduces the time and expense of configuring the working space of frame 225 to receive a re-bar cage of a particular size.

Frame 225 can further includes a first support member holder (not shown) coupled to first stiffener 252a and a second support member holder (not shown) coupled to second stiffener 252b. These support member holders can be similar to the above-described support member holders 58a, 58b that include receiving portions 60a, 60b, respectively. Support member 262 extends at least partially between first column 227a and second column 227b and is removably positioned in the support member receiving portions. Support member 262 is preferably positioned about waist height above the ground. Supplemental support members, as discussed above, can also be coupled holes 251a, 251b of stiffeners 250a, 250b.

Also provided on frame 225 is a hoist assembly 268. In the illustrated embodiment, hoist assembly 268 is secured to first upper arm 240a, although hoist assembly could alternatively be secured positioned to second upper arm 240b. Hoist assembly 268 includes a winch 270, a first pulley 274 secured on upper arm 240a, and a second pulley 275 secured to connecting member 264. A main cable 272 extends from winch 270 through pulleys 274, 275 and downwardly through opening 265 provided through connecting member 264 between first upper arm 240a and second upper arm 240b. A hook and a lower lifting assembly (not shown), such as hook 76 and lower lifting assembly 78 discussed above, can be provided at the end of main cable 272 in the working space defined by frame 225.

The height H3, H4 of each upper arm 240a, 240b and height H1 of support member 262 above the ground can be adjusted by repositioning vertical adjustment pins 236a, 236b in any one of the vertical adjustment holes 234a, 234b formed in lower vertical members 230a, 230b respectively. In one specific embodiment, it is contemplated that holes 234a, 234b provide height adjustment in six inch increments, although other increments are also contemplated. Other means for adjustably securing upper arms 240a, 240b to lower vertical members 230a, 230b are also contemplated, such as, for example, collars that are adjustably secured to the columns. In another alternative, upper arms 240a, 240b could be telescopingly received in lower vertical members 230, 230b.

In one specific embodiment, the components of frame 225 are fabricated from drawn over mandrel tubing and assembled with cold formed hitch pins. In this specific embodiment, the upper arms 240a, 240b and connecting member 264 of frame 225 each have a 2.375 inch outer diameter and a wall thickness of 0.156 inches; stanchions 226a, 226b each have an outside diameter of 2.875 inches and wall thickness of 0.125 inches; and stiffeners 250a, 250b, 252 are provided in the form of plates having a thickness of 0.325 inches. It has been found that in this specific embodiment the load carrying capability of frame 225 is optimized to lift re-bar cage weights up to 2500 pounds while minimizing the overall weight of frame 225 to about 160 pounds. Thus, frame 225 may be easily tilted by a single worker or carried by two workers to the desired location. Furthermore, the components of frame 225 are relatively light in weight and easily carried and assembled by a single worker and transported to and from the job site in light duty trucks.

It is also contemplated that the components of the frames of the present invention can be made of standard or high strength structural steel or other suitable material having the requisite load carrying capabilities. Furthermore, the dimensional attributes of the components can be such that when the frames are disassembled they can be easily stored and hauled to and from the job site. The components of the frames can be fabricated using fabrication techniques known to those skilled in the art from known structural shapes, such as pipes, tubing, beams, angles or channels.

It will be understood that heights H3 and H4 of the frames of the present invention can be different to provide a level and stable frame on uneven ground or floor surfaces. For example, the floor or support surfaces upon which the bases of the frames are to rest may have different elevations and may also be spaced apart at various distances at different locations on the site. The system of the present invention can be adapted for safe and effective use at such a location by providing horizontal and vertical adjustment of the width and height of the frames to allow bases of the frames to rest on these surfaces to stabilize the frame and provide a level support member 62, 162, 262.

In one specific application, the system of the present invention is positioned over a beam pocket or beam form of a structure under construction. Such a structure will typically have support surfaces of differing elevations upon which the stanchions are placed. After adjusting the frames so that they are level, the frames can be used to raise and lower the partially assembled re-bar cages into the beam pocket. This allows the workers to determine the appropriate locations to tie the main re-bars to the transverse re-bars of the cage being assembled based on the spacing of the re-bars extending into the beam pocket from portions of the structure already constructed. The main re-bars will then be properly positioned about the transverse re-bars so that the re-bars extending into the beam pocket can be tied to the main re-bars. The present invention eliminates the time-consuming and difficult manual lifting and holding of re-bars normally required assemble a re-bar cage in a beam pocket to tie the assembled re-bar cage for the beam into existing re-bar structures.

Referring now to FIGS. 1 and 3-6, another use of system 20 to assemble re-bar cage 10 will now be described with respect to frames 25, 125. However, it is to be understood that the re-bar cage assembly techniques discussed herein can also be accomplished with forward and rearward frames having the configuration of frame 225.

As shown in FIG. 1, frames 25, 125 are assembled and adjusted vertically and horizontally as described above to accommodate the size of the re-bar cage and the ground or floor level upon which the frames 25, 125 rest with support members 62, 162 removed. Main re-bars 11 and staging re-bar 12 are located between frames 25, 125. It is contemplated that support members 62, 162 can be placed on the ground in the working space under the respective frame 25, 125 and that the re-bars are then placed on support members 62, 162 to raise them off the ground to facilitate attachment of hooks 76, 176 and lifting assemblies 78, 178 therearound. Hoist cables 72, 172 are then lowered, and staging re-bar 12 is placed in hooks 76, 176. Main re-bars 11 are secured in lifting assemblies 78, 178. Staging re-bar 12 and main re-bars 11 are then lifted to the desired height above the ground with hoisting assemblies 68, 168.

As shown in FIG. 3, support members 62, 162 are positioned below main re-bars 11 in the respective support member receiving portions. As shown in FIG. 4, a number transverse re-bars 13 are then positioned along staging re-bar 12 as dictated by the design requirements for the cage. In the illustrated embodiment, transverse bars 13 are not continuous, and have an opening 16 between the overlapping ends of the bars that allows the ends of the transverse bars to be separated and placed around staging re-bar 12 and main re-bars 11 between hoist cables 72 and 172. Other techniques for placing non-continuous and continuous transverse bars around staging re-bar 12 and main re-bars 11 are described herein below. Transverse re-bars 13 are secured various locations marked along staging re-bar 12 using tie wires 15 forming a partially assembled cage 10 with the desired transverse re-bar spacing. It is contemplated that support members 62, 162 can be positioned in receiving portions 60a, 60b and receiving portions 160a, 160b respectively either before or after transverse re-bars 13 are positioned along staging re-bar 12.

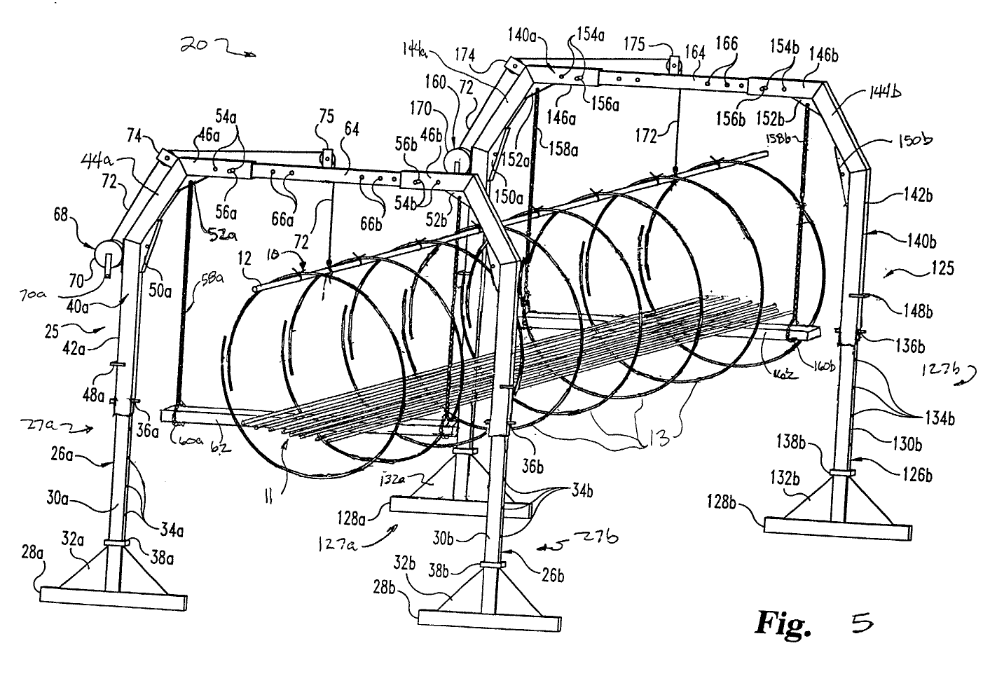

Hoist assemblies 68, 168 can then be used to lower main re-bars 11 onto support members 62, 162 as shown in FIG. 5. Lifting assemblies 78, 178 are removed to uncouple main re-bars 11 staging re-bar 12. Main re-bars 11 are now entirely supported by support members 62, 162. It is also contemplated that main re-bars 11 could be lowered onto support members 62, 162 before placing transverse re-bars 13 along staging re-bar 12. Transverse re-bars 13 can then be spaced along staging re-bar 12 with staging re-bar 12 lowered to waist height adjacent support members 62, 162. Partially assembled re-bar cage 10 may be raised and lowered with respect to support members 62, 162 and thus with respect to mains re-bars 11 via hoist assemblies 68, 168. The ability to raise and lower the partially assembled re-bar cage 10 with respect to main re-bars 11 allows the workers to slide individual ones of the main re-bars 11 along support members 62, 162 and raise or lower transverse re-bars 13 to the desired location with respect to support members 62, 162 to complete the assembly of re-bar cage 10.

To assemble the cage, individual ones of the main re-bars 11 are tied about the inner perimeter of transverse re-bars 13 at the desired spacing. No manual lifting of a main re-bar 11 is required in order to secure it to the transverse re-bars 13. As shown in FIG. 6, main re-bar 11a is secured to cage 10 adjacent staging re-bar 12, and partially assembled re-bar cage 10 has been raised to position another main re-bar adjacent the desired location along transverse re-bars 13 for attachment to transverse re-bars 13. The main re-bars 11 only need to be repositioned along support member 62, 162 adjacent transverse re-bars 13 to complete the assembly of the re-bar cage. Preferably, the partially assembled cage 10 is lifted as it is assembled in a lower position so that individual ones of the main re-bars 11 can be tied to the upper half of each of the transverse re-bars 13. The partially assembled cage 10 is lifted with the hoist assemblies so that the remaining main re-bars 11 can be tied to the lower half of each of the transverse re-bars 13 to complete the assembly of the re-bar cage with the support members 62, 162 located outside and below the assembled re-bar cage 10.

When re-bar cage 10 is completely assembled, hoist assemblies 68, 168 have positioned the assembled cage above support members 62, 162. Thus, support members 62, 162 can be easily removed. Once re-bar cage 10 is assembled, support members 62, 162 are removed. Hoist assemblies 68, 168 are then used to lower assembled re-bar cage 10 to the ground. Frame members 25, 125 can then be tilted about one of their stanchions, and re-bar cage 10 can be rolled out from between the frames. Alternatively, re-bar cage 10 could be pulled lengthwise through frame members 25, 125, or frames 25, 125 could be disassembled to allow a crane or the like to lift re-bar cage 10.

For some re-bar cage designs, it may not be possible to flex transverse re-bars 13 for placement laterally over main re-bars 11 and staging re-bar 12. As shown in FIG. 11, a temporary frame 325 is provided to allow transverse re-bars 13 to be placed endwise over main re-bars 11 and staging re-bar 12. Temporary frame 325 includes a first column 327a spaced from a second column 327b. Columns 327a, 327b each further include a base 328a, 328b and base stiffeners 332a, 332b. First column 327a has a saddle 338a on top thereof and second column 327b has a saddle 338b on top thereof. Saddles 338a, 338b are configured to engage support member 362 extending therebetween when columns 327a, 327b are rotated from their orientation in FIG. 11 so that the side openings of saddles 338a, 338b face one another.

Column 327a can be provided with telescoping upper member 334a and lower member 336a, and column 327b can be provided with telescoping upper member 334b and lower member 336b. The telescoping upper members and lower members each include holes spaced therealong that are alignable to receive an adjustment pin for adjustment of the height of support member 362 above the ground.

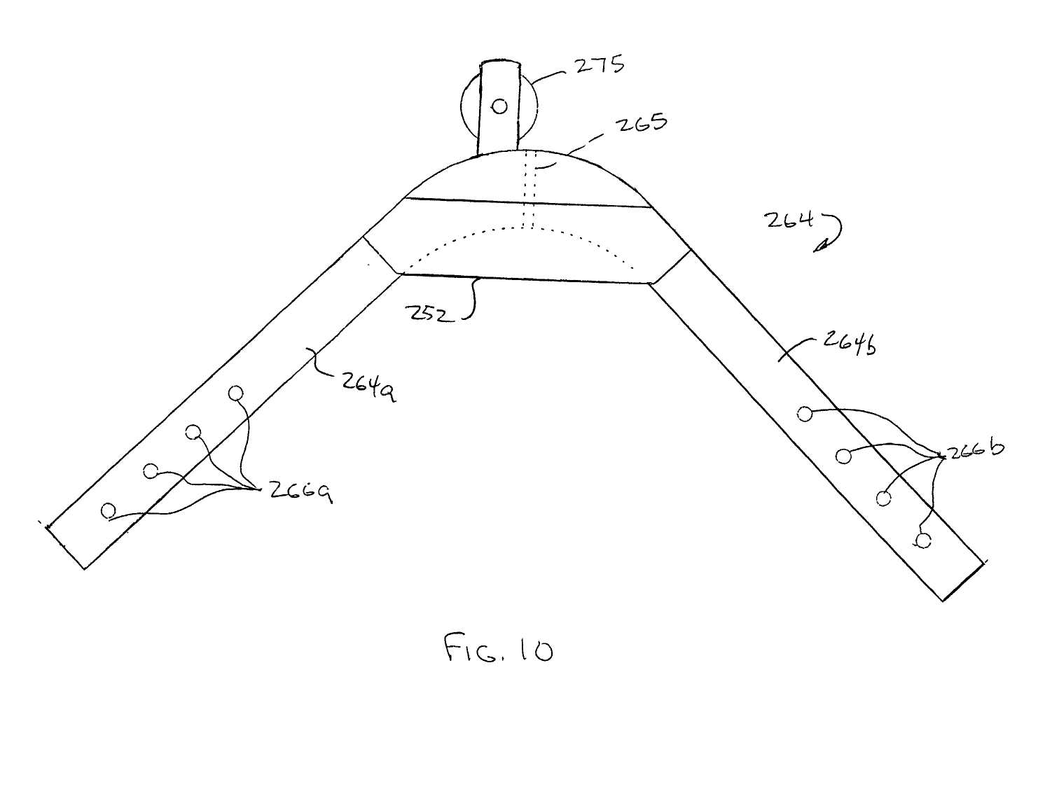

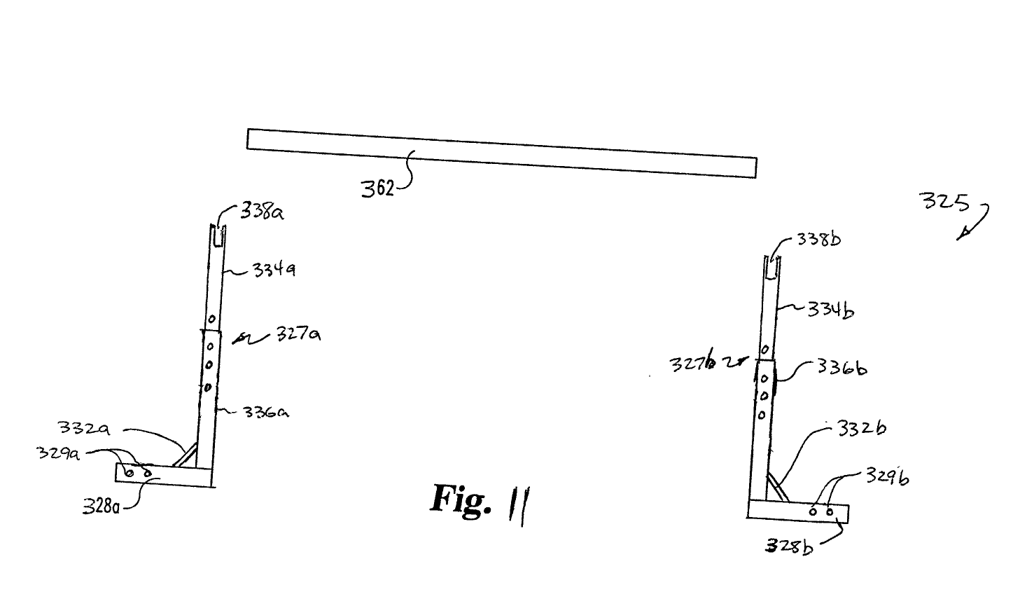

As shown in diagrammatic form in FIG. 12, temporary frame 325 is positioned between forward frame 225 and rearward frame 225′. Bases 328a, 328b extend toward the adjacent frame 225 for attachment to bases 228a, 228b of frame 225. As shown in FIG. 13, base 228b of frame 225 has a first portion extending therefrom sized to telescopingly receive at least a portion of base 328b. Base 228a of frame 225 and base 328a of temporary frame 325 can also be similarly attached. Pin 231b couples temporary frame 325 to frame 225, increasing the stability of frame 325. A number of holes 329a, 329b can be provided in each base 328a, 328b to allow the spacing between frame 225 and temporary frame 325 to be adjusted. It should be understood that the bases of frame 25, 125 could also be configured in the manner discussed with respect to frame 225 to allow attachment of temporary frame 325 thereto.

To use temporary frame 325, main re-bars 11 and staging re-bar 12 are lifted by hoist assemblies and lower lifting assemblies. Temporary frame 325 is positioned between frames 225, 225′. Temporary frame 325 has support member 362 extending between and supported on first column 327a and second column 327b. Main re-bars 11 and staging re-bar 12 are lowered onto support member 362 of temporary frame 325 and support member 262′ of frame 225′. Transverse re-bars 13 are then positioned endwise over the main re-bars and staging re-bar through the working space defined by frame 225 and adjacent temporary frame 325. The lower lifting assemblies are then coupled around main re-bars 11 and staging re-bar 12 to lift them off of support member 362. Temporary frame 325 is removed and support member 262 is coupled to frame 225. Main re-bars 11 and staging re-bar 12 are lowered onto support members 262, 262′. The transverse re-bars are now located between frames 225, 225′ and assembly of re-bar cage 10 proceeds according to the methods discussed herein.

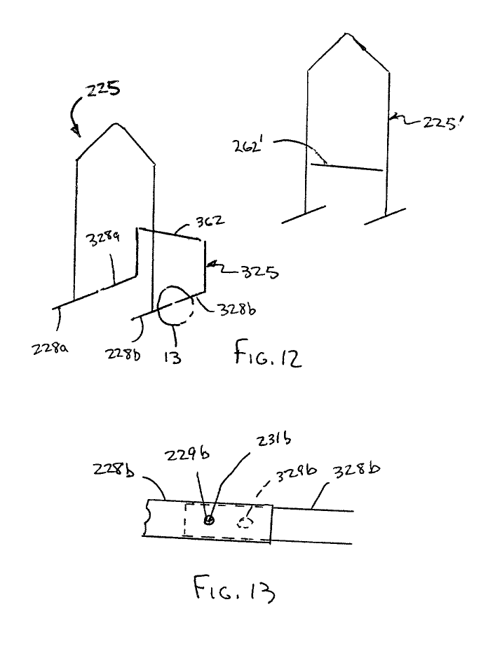

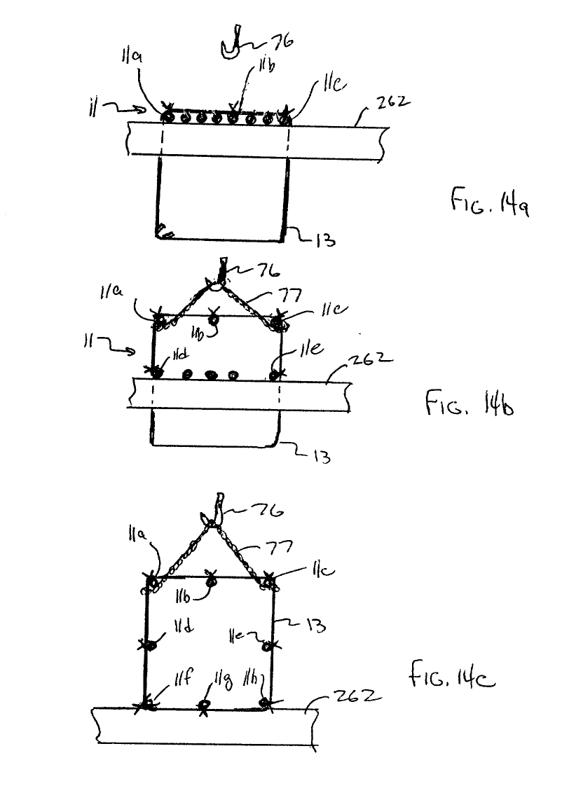

A method for assembling a re-bar cage having a non-circular cross-section will now be described with reference to FIGS. 14a-14c. A plurality of main re-bars 11 are positioned on support member 262 of a first frame (not shown) and a plurality of transverse re-bar 13 are spaced along main re-bars 11 according to the techniques discussed herein. Main re-bars 11 are similarly supported at their opposite end by a second support member of a second frame. Main re-bars are spaced along support member 262 and re-bar 11a is tied to one corner of transverse re-bar 13, re-bar 11c is tied to the other corner of transverse re-bar 13, and main re-bar 11b is tied in the middle of transverse re-bar 13. A lifting assembly 77 is placed around main re-bars 11a, 11c and coupled to hook 76 of a hoisting assembly. The opposite end of main re-bars 11a, 11b, 11c are similarly tied to another transverse re-bar 13 and coupled to a hoisting assembly of the second frame. The partially assembled re-bar cage is then lifted with hoisting assemblies of the first and second frames to positioned the untied re-bars 11 at a second location with respect to transverse re-bar 13. Main re-bars 11d and 11e are then tied at the second location of transverse re-bar 13. The opposite end of main re-bars 11d, 11e are similarly tied to another transverse re-bar 13 at the second frame. The partially assembled re-bar cage is then lifted with hoisting assemblies of the first and second frames to positioned the untied re-bars 11 at a third location with respect to transverse re-bar 13. Main re-bars 11f, 11g and 11h are then tied at the third location of transverse re-bar 13. The opposite end of main re-bars 11f, 11g and 11h are similarly tied to another transverse re-bar 13 at the second frame.

Once the transverse re-bars 13 are secured to the ends of main re-bars 11, the remaining transverse re-bars 13 are tied to main re-bars 11 along the length of the cage between the first and second frames and, if necessary, to the ends of main re-bars 11 extending beyond the ends of the first and second frames. It is also contemplated that each transverse bar can be ties to the main re-bars before the partially assembled cage is lifted for tying at a second location. Internal linear transverse re-bars can also be placed through the middle of re-bar cage 10 and tied to, for example, main re-bar 11b to main re-bar 11g. Internal diamond shaped transverse re-bars can also be placed around a portion of the main re-bars with transverse re-bars 13 in order to couple, for example, main re-bars 11b, 11d, 11e and 11g to one another with the other main re-bars outside the diamond shaped transverse re-bars.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system for assembling a re-bar cage, comprising:
a first frame defining a first working space thereunder, a first support member removably coupled to said first frame in said first working space, and a first hoist assembly mounted to said first frame and extending into said first working space;
a second frame defining a second working space thereunder, a second support member removably coupled to said second frame in said second working space, and a second hoist assembly mounted to said second frame and extending into said second working space; and
a temporary frame positioned between said first frame and said second frame, said temporary frame having a third support member, wherein one end of a plurality of main re-bars are supported by said second support member and the other end of the plurality of main re-bars are initially supported by said third support member with said first support member removed for placement of a number of transverse re-bars over the other end of the plurality of main re-bars and through said first working space of said first frame, said first hoist assembly operable to raise the other end of the plurality of main re-bars and the number of transverse re-bars positioned thereon for coupling said first support member to said first frame below the plurality of main re-bars and for removal of said temporary frame, said first hoist assembly further operable to lower the plurality of main re-bars on said first support member whereby the number of transverse re-bars are located between said first support member and said second support member.

2. The system of claim 1, wherein said temporary frame is adjustably coupled to said first frame to vary the spacing distance between said first frame and said temporary frame.

3. The system of claim 1, wherein said first frame includes a first column, a second column spaced from said first column, and a first member extending between and interconnecting said first column and said second column, said first hoist assembly extending from said first member into said first working space; and
said second frame includes a third column, a fourth column spaced from said third column, and a second member extending between and interconnecting said third column and said fourth column, said second hoist assembly extending from said second member into said second working space.

4. The system of claim 3, wherein said temporary frame includes a fifth column, a sixth column spaced from said fifth column, said third support member extending between and supported by said fifth column and said sixth column.

5. The system of claim 4, wherein said fifth column and said sixth column each have an adjustable height.

6. The system of claim 3, wherein:
said first column and said second column of said first frame each have a vertical portion and a transverse portion extending toward one another; and
said third column and said fourth column of said second frame each has a vertical portion and a transverse portion extending toward one another.

7. The system of claim 3, wherein said first and second columns of said first frame are height adjustable to adjust a height of said first working space defined by said first frame and said third and fourth columns of said second frame are height adjustable to vary a height of said second working space defined by said second frame.

8. The system of claim 7, wherein said first member is adjustable with respect to said first column and said second column to vary a width of said first working space defined by said first frame and said second member is adjustable with respect to said third column and said fourth column to vary a width of said second working space defined by said second frame.

9. The system of claim 3, wherein said first member is adjustable with respect to said first column and said second column to vary a width of said first working space defined by said first frame and said second member is adjustable with respect to said third column and said fourth column to vary a width of said second working space defined by said second frame.

10. The system of claim 1, wherein said temporary frame is positioned adjacent to said first frame.

11. The system of claim 1, wherein:
said first frame is simultaneously adjustable in height and width to vary a height and a width of said first working space defined by said first frame; and
said second frame is simultaneously adjustable in height and width to vary a height and a width of said second working space defined by said second frame.

12. A system for assembling a re-bar cage having a cross-section with a height and a width, the system comprising:
a first frame defining a first working space thereunder, a first hoist assembly mounted to said first frame and extending into said first working space, said first frame being simultaneously adjustable in height and width to adapt said first working space to the height and width of the cross-section of the re-bar cage;
a second frame spaced from said first frame and defining a second working space thereunder, a second hoist assembly mounted to said frame and extending into said second working space, said second frame being simultaneously adjustable in height and width to adapt said second working space to the height and width of the cross-section of the re-bar cage; and
a re-bar cage assembly including a plurality of main re-bars extending between said first frame and said second frame and a number of transverse re-bars around said main re-bars, said first hoist assembly and said second hoist assembly being operable to raise and lower said re-bar cage assembly.

13. The system of claim 12, wherein said plurality of said main re-bars are supportable above the ground by a first support member coupled to said first frame and a second support member coupled to said second frame.

14. The system of claim 13, wherein:
said first frame includes at least one supplemental support member coupled thereto extending into the working space defined by said first frame for engaging said re-bar cage assembly; and
said second frame includes at least one supplemental support member coupled thereto extending into the working space defined by said second frame for engaging said re-bar cage assembly.

15. The system of claim 12, wherein:
said first frame includes a first column, a second column spaced from said first column, and a first member interconnecting said first column and said second column, said first hoist assembly extending into said first working space from said first member; and
said second frame includes a third column, a fourth column spaced from said third column, and a second member interconnecting said third column and said fourth column, said second hoist assembly extending into said second working space from said second member.

16. The system of claim 15, wherein:
said first and second columns of said first frame each include telescoping upper and lower members for adjusting the height of said first and second columns; and
said third and fourth columns of said second frame each include telescoping upper and lower members for adjusting the height of said third and fourth columns.

17. The system of claim 16, wherein said upper members of each of said first and second columns include a handle.

18. The system of claim 16, wherein said first member is telescopingly received in each of said first and second columns and said second member is telescopingly received in each of said third and fourth columns.

19. The system of claim 15, wherein:
said first hoist assembly includes a first pulley mounted to said first member, a first winch mounted to said first column, and a first cable coupled to said first winch and extending around said first pulley and into said first working space; and
said second hoist assembly includes a second pulley mounted to said second member, a second winch mounted to said third column, and a second cable coupled to said second winch and extending around said second pulley and into said second working space.

20. The system of claim 19, wherein said first winch and said second winch each have a friction brake.

21. The system of claim 19, wherein said first cable and said second cable are each swaged at one end thereof, said first and second hoist assemblies each further including a hook coupled to said swaged end of respective ones of said first and second cables.

22. The system of claim 15, wherein:
said first member has an arch shape extending between said first column and said second column; and
said second member has an arch shape extending between said third column and said fourth column.

23. A method for assembling a re-bar cage, comprising:
supporting one end of a plurality of main re-bars;
temporarily supporting the other end of the plurality of main re-bars at a first location along the plurality of main re-bars;
positioning a number of transverse re-bars about the other end of the plurality of main re-bars;
advancing the number of transverse re-bars about the main re-bars to the first location;
supporting the other end of the plurality of main re-bars such that the number of transverse re-bars are located between the supported ends of the plurality of main re-bars; and
removing the temporary support of the plurality of main re-bars.

24. The method of claim 23, further comprising:
spacing the number of transverse re-bars along the plurality of main re-bars between the supported ends of the main re-bars.

25. The method of claim 24, further comprising:
tying a first one of the number of transverse re-bars to one of the plurality of main re-bars at one supported end of the main re-bar; and
tying a second one of the number of transverse re-bars to the one main re-bar at the other supported end.

26. The method of claim 25, further comprising:
lifting the tied main re-bars and transverse re-bars; and
tying the remaining plurality of main re-bars to the transverse re-bars.

27. A method for assembling a re-bar cage, comprising:
supporting one end of a plurality of main re-bars at a first height above the ground;
supporting the other end of the plurality of main re-bars at the first height above the ground;
positioning a plurality of transverse bars along the plurality of supported main re-bars, a first one of the transverse re-bars positioned adjacent the one end of the plurality of main re-bars and a second one of the transverse re-bars adjacent the other end of the plurality of main re-bars, securing two or more of the plurality of the supported main re-bars to the first transverse re-bar at a first location on the first transverse re-bar corresponding to the first height;
securing the two or more of the plurality of the supported main re-bars to the second transverse re-bar at a first location on the second transverse re-bar corresponding to the first height;
lifting the plurality of transverse re-bars and the secured main re-bars to a second height above the ground;
securing one or more of the plurality of main re-bars to a second location on the lifted first transverse re-bar corresponding to the first height; and
securing the second number of the plurality of main re-bars to a second location on the lifted second transverse re-bar corresponding to the first height.

28. The method of claim 27, further comprising:
lifting the plurality of transverse re-bars and the secured main re-bars to a third height above the ground;
securing one or more of the plurality of main re-bars to a third location on the lifted first transverse re-bar corresponding to the first height; and
securing the one or more of the plurality of main re-bars to a third location on the lifted second transverse re-bar corresponding to the first height.

29. The method of claim 27, wherein the plurality of transverse re-bars each have a square shape extending about the plurality of main re-bars.

30. The method of claim 27, further comprising providing supplemental support for the lifted transverse re-bars and the secured main re-bars.
